(19) United States
(12) Patent Application Publication
(10) Pub. No.: US 2025/0377243 A1
(43) Pub. Date: Dec. 11, 2025

(54) SPECTRAL IMAGING SYSTEM, METHOD OF FABRICATING THEREOF AND CAMERA DEVICE

(71) Applicant: Quantum Devices Corp., Halifax (CA)

(72) Inventor: Sean HINDS, Halifax (CA)

(73) Assignee: Quantum Devices Corp., Halifax (CA)

(21) Appl. No.: 19/091,055

(22) Filed: Mar. 26, 2025

Related U.S. Application Data
(60) Provisional application No. 63/658,252, filed on Jun. 10, 2024.

(51) Int. Cl. G01J 3/26; G01J 3/02; G01J 3/28

(52) U.S. Cl. CPC G01J 3/26; G01J 3/0208; G01J 3/2803; G01J 3/2823; G01J 2003/265; G01J 2003/2816; G01J 2003/2826

(57) ABSTRACT

Various embodiments are described herein for a sensor device, a method of manufacturing said sensor device, and a camera device constructed using said sensor device. The sensor device includes: a readout integrated circuit; an array of electrical contacts mounted to the readout integrated circuit; a solution processed layer deposited on top of the array of electrical contacts; and a spectral band filter layer deposited on top of the solution processed layer, wherein the spectral band filter layer is optically aligned with the solution processed layer and wherein the readout integrated circuit, the array of electrical contacts and the solution processed layer form together a focal plane array for receiving light from a lens device.

### CROSS REFERENCE TO RELATED APPLICATIONS

The present application claims priority to U.S. Provisional Application 63/658,252 filed Jun. 10, 2024 the entire contents of which are incorporated herein by reference.

### FIELD

The various embodiments described herein generally relate to spectral imagers, specifically short-wave infrared spectral imagers, methods of manufacturing thereof, and camera devices using spectral imagers.

### BACKGROUND

Infrared spectral imagers respond to specific wavelengths of light that can be used to characterize a desired object, for example methane gas.

Methane emissions, including from natural gas wells and pipelines are a major contributor to greenhouse gas (GHG) emissions. Specifically, Methane has over 25 times the potency of CO₂ as a greenhouse gas. Methane is therefore problematic and controlling it is a high-impact method of reducing climate impacts of extractive industries.

CH₄ has fundamental vibrational modes in the infrared (IR) portion of the EM spectrum, with the main H—CH₃ stretching modes at approximately 3.4 μm and the H—CH₃ deformation modes between 6.8-7.5 μm. Combination bands and the harmonics of these modes make the CH₄ spectrum quite rich in the mid- and near-IR (NIR) regions. Although solid state electrochemical sensors are used in some situations for point monitoring applications, many, if not most, applications use spectroscopic measurements.

A nondispersive infra-red (NDIR) measurement schema can be used to detect gas leaks. In an NDIR measurement, a broadband light source is directed onto a filtered photodiode or other detector. Gas in the path between the light source and the detector generates an absorption signal, which can be used to quantify the gas. For CH₄, the filter is typically in an interference-nonfree region around 3.4 μm: one that is often masked by the standard concentration of atmospheric water. A CH₄ feature that is closer to interference-free is in the region around 2.4 μm.

Non-imaging spectroscopic measurements have a number of disadvantages. Typically, spectroscopic measurements collect light from the full field of view that is suboptimal by definition and thus demonstrate a lower sensitivity for a specific region of interest that is not known a priori. This implementation often limits image formation either in time or in spatial resolution, which is counterproductive to capturing images while in motion or that require spatial resolution toward boundary or field observations. Spectroscopic measurement devices may greatly add to the size, weight, complexity, for example in the case of gratings, prisms or Michaelson interferometers, making them counterproductive for mobile use. The spectral resolution of spectroscopic measurement devices may be too broad and is often proportional to a reduction in optical throughput.

Infrared spectral imagers can also be used to detect gas leaks from the oil and gas industry toward climate policy penalties, equipment repair, personal safety, and to increase operator profitability. Infrared spectral imagers can be useful in mineralogy, laser profilers, and quantum applications among other vision application markets for detection, recognition, or identification needs.

An impediment of conventional infrared spectral imagers is the high cost, and the limited scalability associated with these devices. The infrared epitaxial wafers used in the construction of conventional spectral imagers are limited by the pitch of their regions (through their hybridization devices) and the wafer diameters (through defect rates) which increases the cost of infrared spectral imagers and moreover, limits their scalability. FIG. 1A provides an image of a conventional bump-bonded infrared wafer 100A, showing a die per wafer count of 48 and limited saw length of approximately 1511 millimeters. The saw length refers to the cumulative length of cuts needed to singulate all the die in a wafer.

Another impediment of conventional spectral imagers is the need for optics that are expensive, brittle, and hygroscopic. Conventional infrared optics like CaF₂ are expensive because they are brittle and grinding a curvature for the optic is a more difficult process than it is for materials like BK7. Conventional infrared optics like KBr are expensive because they are hygroscopic and exposure to humidity causes changes in their structure that leads to unwanted scattering effects and are more expensive to produce consequently.

Furthermore, operating current infrared spectral imagers often requires cryogenic systems working at temperatures below those achievable by thermoelectric coolers to demonstrate effective signal to noise performance. Using cryogenic systems typically increases the size, weight, power consumption and cost of the imager. For infrared spectral imagers capable of specific gas identification or quantification the additional impediment of narrow gas spectral lines is challenging without bulky dispersion elements like prism(s), grating(s), Michelson interferometer(s), or other optical techniques that do not sacrifice temporal or spatial resolution significantly.

Another impediment of photodetectors used for conventional infrared spectral imagers is the use of longitudinal (parallel optical and electric field) architectures. In longitudinal architectures, the absorbance length of the material can limit its fundamental performance where: the resulting signal is strongly dependent on targeting the optimal length of material to match is absorbance, thus limiting repeatable manufacturing, its quantum efficiency is inherently limited to about 87% of what the material is capable of, thus limiting its sensitivity, and the noise performance is dependent on the length of the material and typically suboptimal, thus limiting its overall contrast performance. As such, conventional infrared spectral imagers do not typically have the size, cost, or scalability needed for widespread usage in growing markets like methane gas leak detection in Oil and Gas and call for improved devices.

Another impediment of conventional photodetectors is their reliance on a vertical stack architecture. Conventionally, existing sensors are created using a vertical stack using materials that are layered one on top of the other, such as InGaAs on InP or on GaAs. This vertical topology stack limits the usefulness of transparent conductors such as ITO (Indium-Tin-Oxide). These vertical stack architectures are complex and expensive to manufacture. Additionally, they are undesirable because the increased number of layers required reduces the transmission of light through the photodetector.

### SUMMARY OF VARIOUS EMBODIMENTS

In a first aspect there is provided a sensor device comprising: a readout integrated circuit; an array of electrical contacts mounted to the readout integrated circuit; a solution processed layer deposited on top of the array of electrical contacts; and a spectral band filter layer deposited on top of the solution processed layer, wherein the spectral band filter layer is optically aligned with the solution processed layer and wherein the readout integrated circuit, the array of electrical contacts and the solution processed layer form together a focal plane array for receiving light from a lens device.

In one or more embodiments, the spectral band filter layer may be configured to permit a propagation of incident light within a first wavelength band therethrough while preventing a propagation of incident light of the second light therethrough, the first wavelength band corresponding to the resonance frequencies of the molecules.

In one or more embodiments, the spectral band filter layer may include at least a first layer and a second layer, a refractive index of the first layer greater than a refractive index of the second layer.

In one or more embodiments, a gap between the first layer and the second layer may be adjustable, and the adjustment of the gap adjusts the first wavelength band and the second wavelength band.

In one or more embodiments, the sensor device may further include an adjustment means for providing the adjustment of the gap.

In one or more embodiments, the first wavelength band may include a first range from 2000 nm to 2500 nm and the second wavelength band may include a second range from 500 nm and 1900 nm and a third range above 2500 nm.

In one or more embodiments, the spectral band filter layer may include a bandpass filter.

In one or more embodiments, the spectral band filter layer may comprise a Fabry-Perot etalon.

In one or more embodiments, the spectral band filter layer and the solution processed layer may comprise a Fabry-Perot etalon.

In one or more embodiments, the sensor device may further include an adhesive layer positioned between the spectral band filter layer and the solution processed layer, the adhesive layer securing the spectral band filter layer and the solution processed layer.

In one or more embodiments, the sensor device may include a horizontal/transverse stack configuration.

In one or more embodiments, the solution processed layer may include quantum dots.

In one or more embodiments, the sensor device may further include at least one microlens structure adjacent to the spectral band filter layer.

In a second aspect there is provided a method for fabricating a sensor device, the method comprising: preparing a substrate; fabrication of an array of electrical connections; preparing a solution processed layer; opto-electronically coupling the solution processed layer to the array of electrical connections; and attaching the spectral band filter layer to the solution processed layer; wherein the sensor device comprises a horizontal stack configuration.

In one or more embodiments, the method may further include fabricating/deposition of blocking layers.

In one or more embodiments, the substrate preparation step may include: cleaning of the substrate; exposing trenching regions with photoresist; developing of photoresist; etching into the substrate material; deposition of the metal(s) contacts; lifting-off solvent; and applying a final protection with photoresist.

In one or more embodiments, the quantum dot preparation may include: depositing at least one electrical contact; depositing a material via solution processed deposition; depositing at least one carrier blocking region; and depositing semiconductor material layers for the formation of photodetectors.

In one or more embodiments, opto-electronically coupling the solution processed layer to the array of electrical connections may include: depositing a quantum dot solution onto a substrate; and crosslinking of the quantum dots with inorganic or organic ligands.

In one or more embodiments, the inorganic or organic ligands may include: ethanedithiol or others, mercaptan, carboxylates, amines, and halogens.

In one or more embodiments, attaching the spectral band filter layer to the solution processed layer may include: depositing high and low refractive index materials on a substrate; and thermally coupling the filter layer to a cold shield.

In a third aspect, there is provided a camera device for sensing spectrophotometric and image data, the camera device comprising: a lens for transmitting incident light; a dispersion device for dispersing the incoming light into a spectrophotometric signal comprising spectrometer data; the sensor device one of the sensor devices described herein for receiving an image from the lens and the spectrophotometric signal from the dispersion device.

In one or more embodiments, the dispersion device may exhibit a Fabry-Perot behavior.

In one or more embodiments, the spectrophotometric signal may include an interference pattern.

In one or more embodiments, the spectrophotometric signal may include a set of concentric circles superimposed upon the image.

In one or more embodiments, the dispersion device may be tuned to a resonant frequency of Methane (CH4).

In one or more embodiments, the sensor device may include a processor in communication with the sensor device, the processor receiving the image and the spectrophotometric signal.

In one or more embodiments, the sensor device may include: a memory in communication with the processor, the memory comprising program instructions which when executed by the processor provide a machine vision algorithm for processing the received image and the spectrophotometric signal.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and in which:

FIG. 1A is a diagram of a conventional imaging sensor; shown according to an example embodiment.

FIG. 1B is a diagram of an imaging sensor, shown according to an example embodiment.

FIG. 2A is a chart showing the transmittance of various gases according to their resonance frequencies.

FIG. 2B a chart showing the transmittance of various gases according to their resonance frequencies.

FIG. 3 is an image of an imaging sensor, according to an example embodiment.

FIG. 4 is a diagram showing a sensor device, according to an example embodiment.

FIG. 5 is a block diagram showing an embodiment of an imaging system, according to at least one embodiment.

FIG. 6 is a block diagram showing an embodiment of a camera system, according to at least one embodiment.

FIG. 7A is a block diagram showing an embodiment of an imaging system, according to at least one embodiment.

FIG. 7B is a block diagram showing an embodiment of an imaging system, according to at least one embodiment.

FIG. 8 is a diagram of a sensing device, according to an example embodiment.

FIG. 9 is a diagram showing an embodiment of an imaging system, according to at least one embodiment.

FIG. 10 flowchart showing a method of fabricating a sensing device, according to at least one embodiment.

### DETAILED DESCRIPTION OF THE EMBODIMENTS

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or processes described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

It should also be noted that the terms “coupled” or “coupling” as used herein can have several different meanings depending on the context in which these terms are used. For example, the terms coupled, or coupling can have a mechanical, electrical or communicative connotation. For example, as used herein, the terms coupled or coupling can indicate that two elements or devices can be directly connected to one another or connected to one another through one or more intermediate elements or devices via an electrical element, an electrical signal, a light signal or a mechanical element depending on the particular context.

It should also be noted that, as used herein, the wording “and/or” is intended to represent an inclusive-or. That is, “X and/or Y” is intended to mean X or Y or both X and Y, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

Similarly, throughout this specification and the appended claims the term “communicative” as in “communicative pathway”, “communicative coupling”, and in variants such as “communicatively coupled” is generally used to refer to any engineered arrangement for transferring and/or exchanging information. Examples of communicative pathways include, but are not limited to, electrically conductive pathways (e.g., electrically conductive wires, physiological signal conduction), electromagnetically radiative pathways (e.g., radio waves, optical signals, etc.), or any combination thereof. Examples of communicative couplings include, but are not limited to, electrical couplings, magnetic couplings, radio couplings, optical couplings or any combination thereof.

It should be noted that the term “coupled” used herein indicates that two elements can be directly coupled to one another or coupled to one another through one or more intermediate elements.

The various embodiments described herein generally relate to SWIR (short-wave-infra-red) imaging systems for identifying gas emissions, including, but not limited to: natural gas emissions, organic compound emissions, poisonous gas emissions, greenhouse gas emissions, and the like. Specifically, gases including but not limited to water vapor, carbon monoxide, carbon dioxide, methane, aerosols, cloud vapor, O₃, O₂, O₄, HCCHO, SO₂, BrO, OClO, ClO, NO, NO₂, NO₃, H₂O can be detected using the quantum material-based imaging systems. The quantum-based imaging systems can be used to identify gas leaks and can help implement mitigation procedures.

The quantum-based imaging systems provided herein can be used without the need for cryogenic systems, working at temperatures between 4° K and 77° K. This may be advantageous for detecting gas leaks nearer to ambient temperatures.

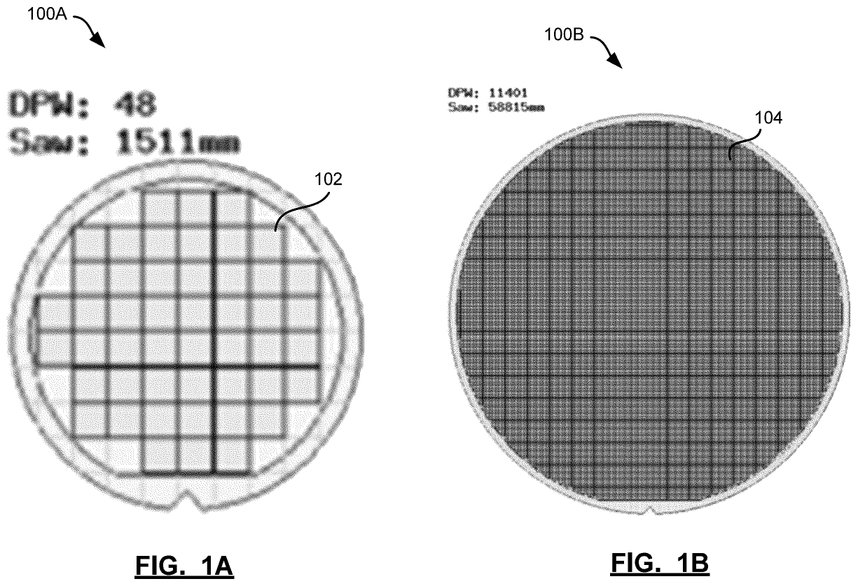

In at least one embodiment, the quantum-based imaging systems provided herein can be manufactured in a scalable way. For example, and as shown in FIG. 1B, a die per wafer count of 11401 is achieved on a saw of 58815 microns. As compared to a conventional sensor device as shown in FIG. 1A, the method of manufacturing the imaging system provided herein can be increased significantly. In at least one embodiment, the method of manufacturing provided herein can produce a pixel pitch ranging between 1 and 30 microns, with a preferable range between 1 and 5 microns.

The quantum-based imaging systems provided herein can also be used to detect gases having a resonance frequency between 250 nm and 2600 nanometers. In at least one embodiment, the imaging system may be advantageous for detecting methane gas, whose resonance frequencies occur in the range of 2100 nm and 2500 nm.

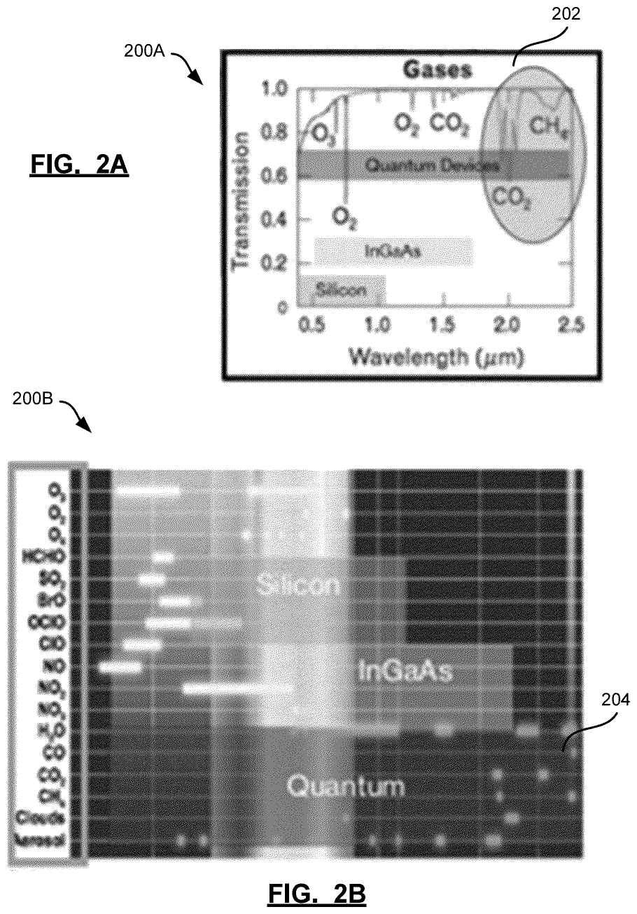

Referring now to FIG. 2A, shown therein is a chart showing the absorbances of various gases according to their resonance frequencies for silicon-based sensors, InGaAs based sensors, and Quantum-based imaging sensors taught herein. Silicon sensors can be used to detect resonance frequencies in the range of about 300 nm to about 1100 nm. Gases including Ozone and Oxygen have resonant frequencies around 600 nm to 750 nm and thus can be detected using silicon sensors. Silicon sensors are typically not used for detecting gases having resonance frequencies greater than 1100 nm because they are not sensitive to wavelengths beyond the near-infrared range (approximately 1100 nm). Silicon has an electronic bandgap that limits its sensitivity to longer wavelengths, making it unsuitable for detecting longer-wavelength light.

To detect gases with resonance frequencies beyond 1100 nm, other materials or sensor technologies that are sensitive to those wavelengths, such as InGaAs (Indium Gallium Arsenide) or MCT (Mercury Cadmium Telluride) sensors are used. InGaAs and MCT have bandgaps that allow them to detect light in the infrared and longer-wavelength ranges, making them suitable for applications requiring sensitivity to those wavelengths. Specifically, lattice matched InGaAs sensors can be used to detect resonance frequencies in the range of about 500 nm to about 1680 nm. Gases including Oxygen and Carbon Dioxide have resonant frequencies between 600 nm to 1750 nm and thus can be detected using InGaAs sensors.

In at least one embodiment, quantum-based sensors can be used to detect gases with resonance frequencies beyond 1680 nm. In at least one embodiment, quantum-based sensors can be used to detect gases between 250 nm to 2500 nm and beyond. In at least one embodiment, quantum-based sensors can be used to detect gases with resonance frequencies in the Infrared, near-infrared spectrum (NIR), or short-wave infrared (SWIR) wavelength ranges. Gases including Methane and Carbon Dioxide have resonant frequencies between 2000 nm to 2500 nm and thus can be detected using the quantum-based sensors taught herein.

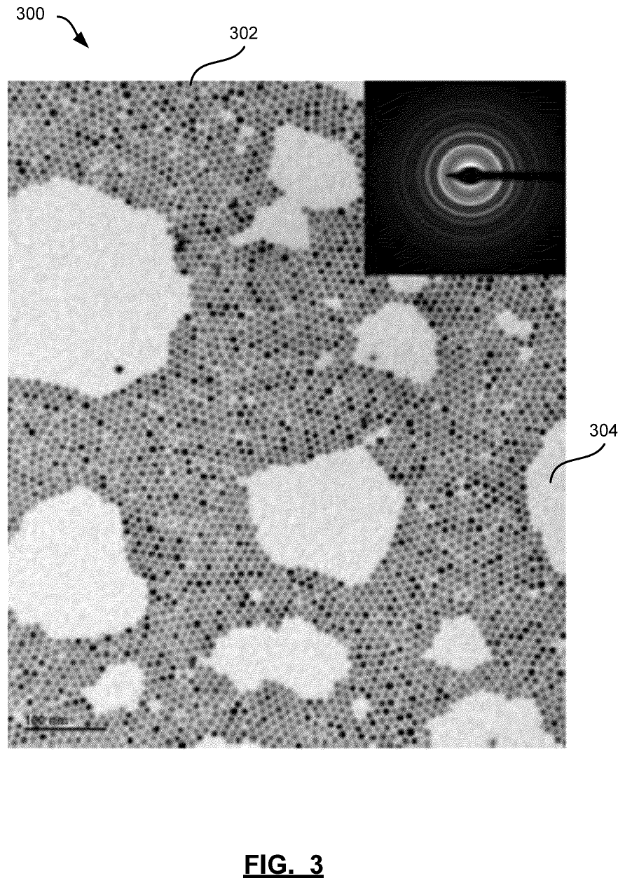

FIG. 2B a chart showing the absorbance spectra of various gases according to their resonance frequencies. In at least one embodiment, the quantum-based sensors can be used to detect the presence of water vapour, carbon monoxide, carbon dioxide, methane, aerosols, and cloud vapor. It can be useful to detect the presence of these gases as some gases such as carbon monoxide are toxic to human beings even at small concentrations and need to be detected quickly and accurately. Other gases such as methane can leak from natural gas wells and pipelines and are a major contributor to greenhouse gas (GHG) emissions thus also need to be detected quickly and accurately. FIG. 3 is an image of an individual quantum dots, according to an example embodiment.

### Sensor Device

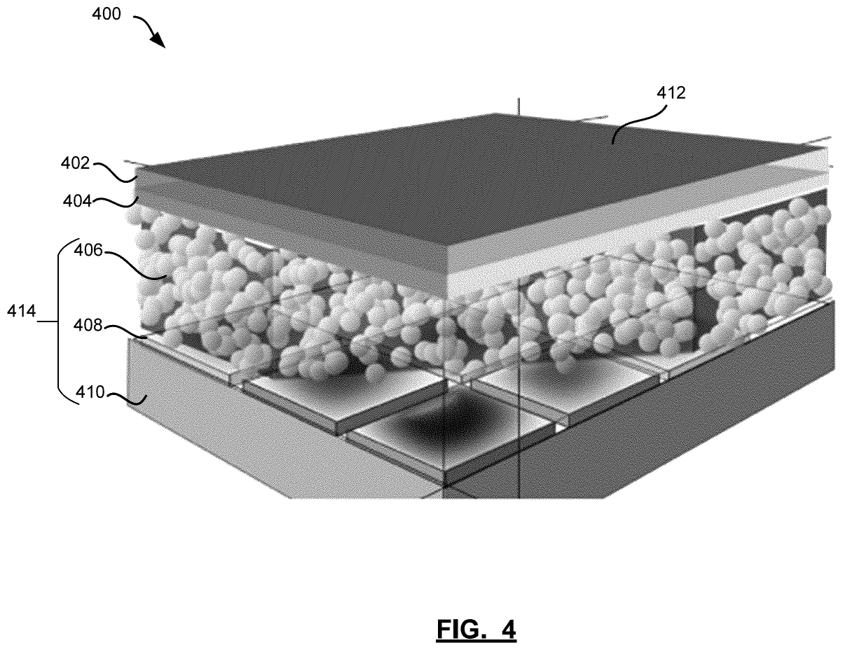

Turning now to FIG. 4, provided therein is a diagram showing a sensor device 400, according to an example embodiment. The sensor device 400 is composed of a substrate 410 including a readout integrated circuit, with an array of electrical contacts 408 mounted to the readout integrated circuit 410, solution processed layer(s) 406 deposited on top of the array of electric contacts 408, an optional adhesive layer 404 for optically aligning the above optional filter layer 402, and a spectral band filter layer 402 deposited on top of the adhesive layer 404 and which is optically aligned to the substrate to minimize distortion in transmitted light.

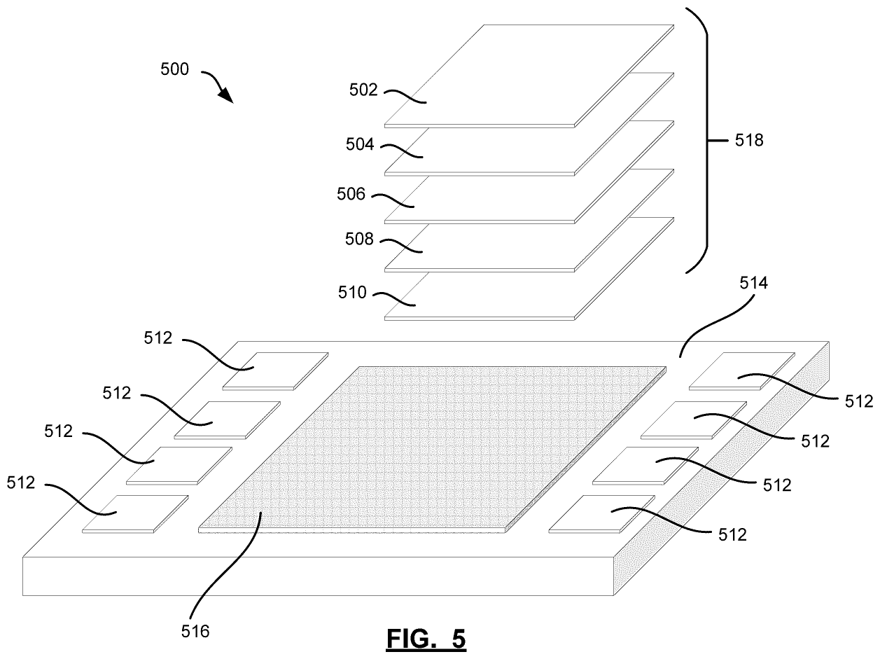

In at least one embodiment, the substrate 410, array of electrical contacts 408, the solution processed layer 406, and the adhesive layer 404 may form a focal plane array (FPA). In one or more embodiments, the solution processed layer 406, the array of electrical contacts 408 and the substrate 410 are constructed using a sandwich construction as shown in FIG. 5.

The substrate 410 provides an area upon which the sensing device 400 is constructed and includes a readout integrated circuit (ROIC). In at least one embodiment, the substrate 410 can be a semiconductor substrate. In at least one embodiment, the substrate 410 can be composed of a suitable semiconductor substrate material. In at least one embodiment, the substrate material can be at least one of the following: silicon, glass, ceramics such as alumina or zirconia, polymers such as PDMS, or quartz.

In at least one embodiment, the ROIC of the substrate 410 can include transverse pixel contacts to contact the array of electrical contacts 408. The transverse pixel contacts can help improve some of the performance traits of the sensing device. In transverse topology it is possible to achieve superior normalized responsivity as a function of absorptance. Also, in transverse topology it is possible to fabricate high speed circuits with 2d electrode deposition topologies.

An array of electrical contacts 408 is provided mounted to the ROIC of the substrate 410. The array of electrical contacts 408 may be a metallic array that permits the conduction of signals generated by the solution processed layer 406 to the ROIC of the substrate 410.

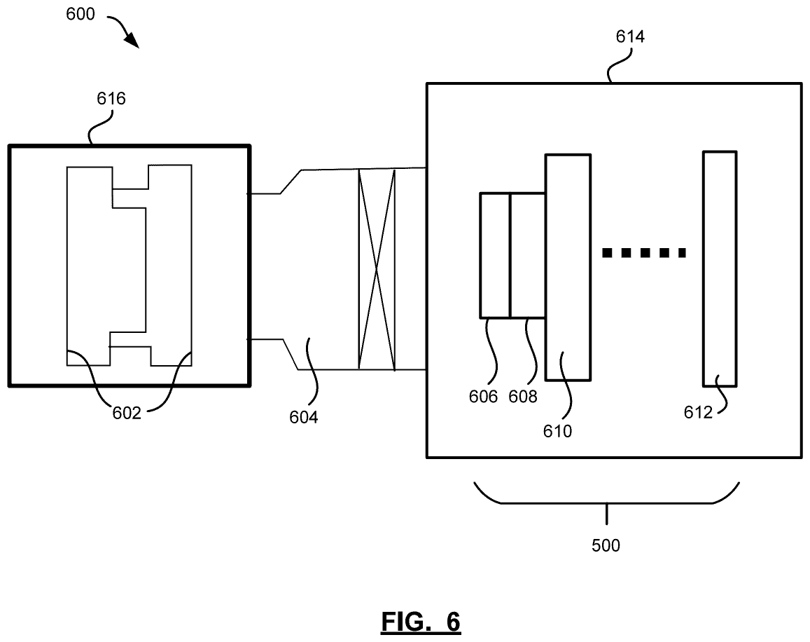

The sensor device 400 may receive light from a field of view through a lens, and one or more optical devices such as a dispersion device (e.g. see FIG. 6).

The lens may focus the received light upon the focal plane array. In at least one embodiment, the array of electrical contacts 408 and the regions of the solution processed layer 406 connected to each electrical contact form array of light-sensing regions. The light sensing regions may be referred to herein as pixels. The FPA may include an arrangement of the light sensing regions having a separation between each adjacent light sensing region. The solution processed layer 406 deposited upon the array of electrical contacts may cooperate with each contact to provide for the detection of signals of interest within the field of view.

In at least one embodiment, the solution processed layer 406 can include any material having a bandgap that allows the material to detect light in the infrared, NIR, or SWIR wavelength ranges. The spectral band filter layer 402 may be optically aligned with the solution processed layer 406. In at least one embodiment, the solution processed layer 406 can include quantum dots (QDs) or other solution processed semiconductor materials. The solution-processed layer 406 may comprise semiconductor materials (e.g. GaAs, Si, etc.) including solution processed materials such as organometallic, perovskites, or nanocrystal suspensions. The solution processed materials may further include polymers and small molecules and any semiconductor material that is deposited from solution. These include, but is not limited to, solution processed materials like CuInGaSe, chalcogenide perovskites, and semiconductor nanocrystal suspensions including quantum dots like PbS, and CdSe as non limiting examples.

In one embodiment, solution processed materials can include semiconductor materials such as cadmium selenide (CdSe), cadmium sulfide (CdS), or indium arsenide (InAs).

In one embodiment, solution processed materials may include metallic elements such as gold, silver, or platinum.

In one embodiment, solution processed materials may include graphene quantum dots and carbon dots, which may be made of carbon atoms arranged in a specific structure.

In one embodiment, solution processed materials may include quantum dots that are based on perovskite materials, including but not limited to: Methylammonium Lead Iodide, Formamidinium Lead Iodide, Cesium Lead Iodide, Mixed Halide Perovskites, and Organic-Inorganic Hybrid Perovskites.

In one embodiment, solution processed materials may include quantum dots that are typically synthesized as colloidal nanoparticles suspended in a solvent.

An adhesive layer 404 may be provided in order to optically align the spectral band filter layer 402 and the focal plane array (i.e. the solution processed layer 406 and below).

In at least one embodiment, the spectral band filter layer 402 may be a bandpass filter layer that uses resonance in order to accept the frequencies generally around the wavelength of the target gas bonds and reject others. The spectral band filter layer 402 is optically aligned with the focal plane array meaning its position and rotation states are set typical toward minimizing optical distortions in the image plane. In this case, fine order filtering is provided by a Fabry-Perot device, and the general bandpass range of interest is provided by layer 402. However, we note it is possible and consistent with this disclosure that both of these functions can be integrated into layer 402. For example, if the target gas is methane gas, the band filter layer 402 accepts the frequencies generally around the wavelength of methane bonds (2000 nm to 2500 nm) and rejects the frequencies between 500 nm and 1900 nm; and above 2500 nm. The bandpass filter achieves this by careful layering of high refractive index and low refractive index materials (such as aSi, SiO₂, SiNₓ, or Ta₂O₅) that cause a designed set of wavelengths to be highly reflected and others to be highly transmitted. Similarly, the bandpass filter can be tuned to accept individually or simultaneously another target gas like CO₂.

The spectral band filter layer 402 may include the Fabry-Perot device as noted above. In one embodiment, the spectral band filter layer 402 and the solution processed layer 406 may together provide the Fabry-Perot device. For example, the array of electrical contacts 408 (i.e. the ROIC) may be made reflective, and the Fabry-Perot device may exist between the surface of the array of electrical contacts 408, the solution processed layer 406 and the spectral band filter layer 402.

In at least one embodiment, a dispersion device is provided in the field of view (e.g. dispersion device 616, see FIG. 6). The dispersion device the, e.g., prism, interferometer, etc., disperses incoming light into chromatic components. The dispersion device can provide a spectral signal that includes spectrometer data that is superimposed against the produced IR image received at the FPA. The components of the dispersion layer are two parallel partially reflective surfaces with a controlled gap or material between them. This device may be a Fabry-Perot etalon, allowing a narrow comb of specific frequencies to pass and be tuned as a function of angle, gap distance or material refractive index or other means.

### Imaging System

In at least one embodiment, the sensor device 400 can be coupled with a readout circuit disposed in substrate 410 to form an imaging system. FIG. 5 is a block diagram showing an embodiment of the imaging system 500, according to at least one embodiment.

The imaging system 500 comprises a photodetector stack 518; coupled to a readout integrated circuit (ROIC) 514. The photodetector stack 518 can consist of the solution processed layer 406 described in FIG. 4. In at least one embodiment, the photodetector stack 518 comprises: a hole transport layer 510, a quantum dot absorber 508, an electron transport layer 506, a top contact 504 and an encapsulation layer 502. In another embodiment, the photodetector stack 518 comprises: an electron transport layer 510, a quantum dot absorber 508, a hole transport layer 506, a top contact 504 and an encapsulation layer 502.

The photodetector stack 518 can be coupled to, or contacted with a ROIC 514. The ROIC 514 comprises a substrate, contact pads 512 and an array of electrical contacts 516. The ROIC 514 can be a CMOS ROIC, Capacitive Feedback ROICs, Charge-Coupled Device (CCD) ROICs, Time-Delay Integration (TDI) ROICs, or any other suitable ROIC. In at least one embodiment, the photodetector stack 518 can be monolithically integrated on the ROIC 514, meaning that the photodetector stack and the readout circuitry are fabricated together on the same semiconductor substrate using the same manufacturing process. Monolithic integration can allow for a more compact and efficient design compared to using separate components for the photodetector and the readout circuitry.

### Optical Configuration of the Camera System

The imaging system 500 can be used within, and form a part of, a camera system 600, as shown in FIG. 6. The optical configuration of the camera system 600 includes the camera body 614, consisting of the imaging system 500; a lens 604, and dispersion device 616 having interferometers 602.

In this embodiment, the camera body 614 comprises a spectral band filter layer 606 the focal plane array 608, the substrate 610, and the readout circuitry 612. Further printed circuit board electronics can be located between the cooling shield 610 and the electronics 612. These components together comprise the imaging device 500.

The imaging system 600 includes at least one dispersion device 616, for example a Fabry-Pérot interferometer 602. Fabry-Perot interferometers (FPIs) can achieve compact spectral interference and is capable of producing interference patterns that can be used to separate and analyze different wavelengths (colors) of light in a compact space. FPIs can consist of two partially reflecting surfaces placed parallel to each other with a gap between them. When light passes through the gap, some of it is reflected back and forth between the surfaces, creating interference patterns. By adjusting the gap between the surfaces, FPIs can selectively transmit or reflect certain wavelengths of light making them useful for spectral analysis. FPIs can also achieve this wavelength separation and analysis in a relatively small and compact device compared to other spectral analysis techniques. This compactness makes FPIs suitable for applications where space is limited, such as in portable or miniaturized spectrometers.

The dispersion device 616 is placed in the optical path toward the infrared focal plane array and may be implemented as a Fabry-Perot interferometer. The dispersion element provides high throughput dispersion and wavelength resolution while maintaining the requirement of compact imaging for combining spectrophotometric and image information simultaneously. The Fabry-Perot interferometer architecture is unlike that of a prism, grating, or Michaelson interferometer, etc., and compactly provides a spectrophotometric signal that includes spectrometer data superimposed against an optical image, which can be distracting for human interpretation but is well adapted for machine vision interpretation. This may include a processor in communication with the sensor device where the processor loads and executes program code containing instructions providing a machine vision algorithm for processing the image and an associated spectrophotometric signal. The Fabry-Perot etalon provides characteristic interference fringes that can be the spectral envelope of the sensed gas, or generalized object's, spectral features of interest within the optical bandpass of the following cold-shield optical filter 610.

The imaging system 600 includes at least one lens 604 or array of lens elements that focus the incident light onto the elements of the focal plane array 608. In some instances, the lens or FPA can also have a role in selecting the spectral band. The lens can also cover the spectral band in question, for example, in the case for methane about 2.5 micron wavelength.

Transmission and dispersion for the lens material are functions of wavelength. For example, OH groups in SiO2 absorb light in the MIR, sapphire starts to lose its ability to transmit light above about 5 microns, Silicon stops transmitting above about 8 microns and again transmits light at about 40 microns, and so on. Dispersion is also dependent on wavelength. Ideally, dispersion should remain fairly constant to ensure that light is bent uniformly by the lens. This allows the light to be accurately directed onto the intended pixel array, preventing it from creating noise on unintended regions and ensuring proper focus.

In summary, targeting an implementation of the technology for a feature at a specific wavelength, such as X microns, and setting up a band-pass filter (BPF) and dispersion layer appropriate for that wavelength would be ineffective if the lens used did not transmit light effectively in that region or exhibited poor dispersion properties.

The focal plane array (FPA) 608 also plays a role in this context. Instead of requiring transmission, the FPA is designed to receive light, which is dependent on wavelength and, to a first approximation, its bandgap. Additionally, a secondary consideration is the location within the FPA where the light is absorbed, and the distance carriers must travel to reach the contacts in the array of electrical contacts without too much loss.

The imaging system further includes a spectral band filter layer 606 that allows some wavelengths of light to be selectively admitted, while rejecting other wavelengths of light. The width of the spectral band filter layer 606 is adjustable via an adjustment means, as is its transmitted cone of angular acceptance transmits the selected light, and when adjusted the wavelengths of light that are transmitted to the sensor material is specifically selected form otherwise background noise. The spectral band filter layer 606 can be mounted directly to the image sensor. The spectral band filter layer 606 can be thermally connected to the sensor's temperature which is actively cooled resulting in a compact cold-shield.

The optical configuration of the imaging system allows for the fine tuning and adjustment of the IR camera to provide a high-resolution image with detailed spectral content information. This may include mechanically controlled configuration, i.e. adjustment with a screw, piezo or motor-based control, temperature control, etc. A spectral signal can also be superimposed on a regular image is projected onto the FPA 608 which is read out by the ROIC 612.

In the embodiment of solution processed materials the sensor material sits on top of an ROIC circuit 612, which, in some cases, must be very flat so that the surface is uniform (otherwise it is possible for cracks to occur when a coating is applied). The opto-electronic connections from the sensor are formed to connect the FPA externally to a processor for image processing.

The focal plane array (FPA) 608 is composed of a material that responds to light by generating carriers for optoelectronic transduction in the focal plane of the optics. Above this element is the angular bandpass filter 606 thermally connected compacted cold shield that selects one or many channels of incoming signal light in a narrow chromatic band and rejects a significant fraction of background (including self background) light with the specific advantages outlined above.

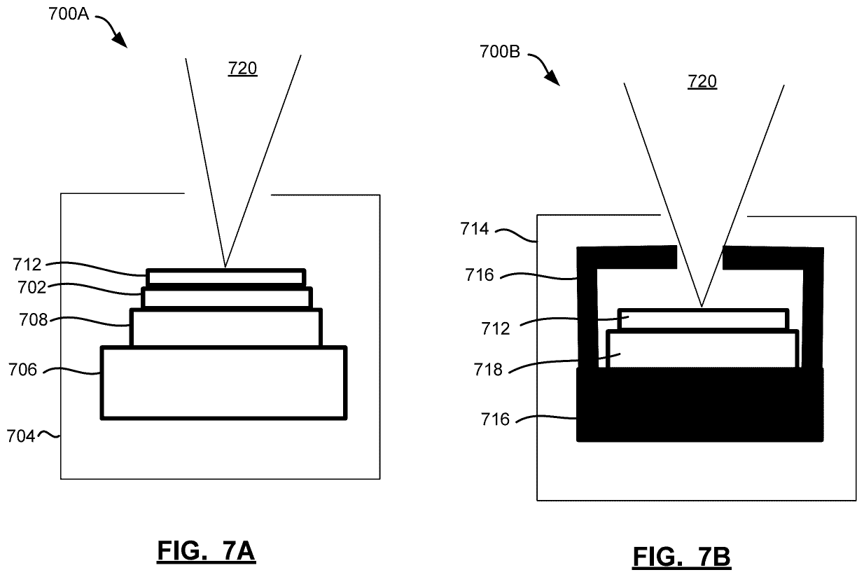

FIG. 7A is a block diagram showing an embodiment of an imaging system 700A, according to at least one embodiment. In this embodiment, the imaging system 700A comprises: a thermoelectric cooler layer 706; a ROIC 708 coupled to the thermoelectric cooler layer 706, an optical filter layer 702, and a sensor layer 712. The imaging system can be housed in a camera housing 704. When incident light 720 travels into the imaging system, it is captured by the sensor layer 712. The optical filter layer 702 uses resonance to accept the frequencies generally around the wavelength of the target gas bonds and reject others. The accepted frequencies are read-out by the ROIC 708. The purpose of the TEC is to provide a uniform and lower temperature for the imaging array; and to reduce the heat in the bandpass layer.

FIG. 7B is a block diagram showing an embodiment of an imaging system 700B, according to at least one embodiment. In this embodiment, the imaging system 700B comprises: a cold shield 716; a ROIC 718 coupled to the cold shield 716, and a sensor layer 712. The imaging system can be housed in a camera housing 714.

In this embodiment, the angular bandpass filter 716 doubles as a compact cold shield 716. The frequency selectivity of the sensor may be tuned to other molecules, including methane, carbon monoxide, etc. The spectral band filter layer uses resonance in order to accept the frequencies generally around the wavelength of methane (or of interest) absorption bands, reject others.

The spectral band filter layer is thermally connected to a cooling device 706 to either limit self background absorbed photons or to lower dark current. The cold shield component is connected thermally to a cooling device to either limit self background absorbed photons that otherwise add to noise that can distort signal in the device. When weak signal sources need to be detected against larger background-absorbed photons, reducing the dark current can improve the signal to noise ratio of the detector, proportional to its square root.

A significant component of the background flux is from the thermal photons emitted as black body radiation from the camera itself. Enveloping the sensor material with a cold shield can eliminate a significant portion of noise and improve camera contrast and performance. In addition, the angular acceptance of the incident light is tuned by the material stack in the optical filter. The cold shields that are commonly used in infrared cameras are typically bulky. Instead, thermally linking the angularly tuned optical bandpass filter directly to the sensor can accomplish the same role in a more compact form while improving specific detectivity by up to two orders of magnitude. An angular bandpass filter thermally connected to a compacted cold shield can be used in one embodiment. The filter selects one or many channels of incoming signal light in a narrow chromatic band and rejects a significant fraction of background (including self background) light.

The thermally linked optical band pass filter can have the ability to select one or many spectral band regions across the pixel space, or to use diverse underlying solution sensor depositions to achieve the same result, to create chromatic channels, or just one channel of interest. The filter layer can also act as part of a concentrator and could have micro lens array adjacent to it. In at least one embodiment, a scattering structure designed into the ROIC for concentration of light can be used for enhanced sensing regions of the solution deposited semiconductor material.

The cold-shield optical filter can be an optical wavelength bandpass filter that transmits light from a designed angular cone of acceptance and reflects light at other wavelengths and angles of incidence. The cold-shield optical filter can perform the role of a compact cold shield and filter layer. The frequency selectivity of the sensor may be tuned to other molecules, including methane, carbon monoxide, etc. by the combined selectivity of the dispersion element and this cold shield optical filter.

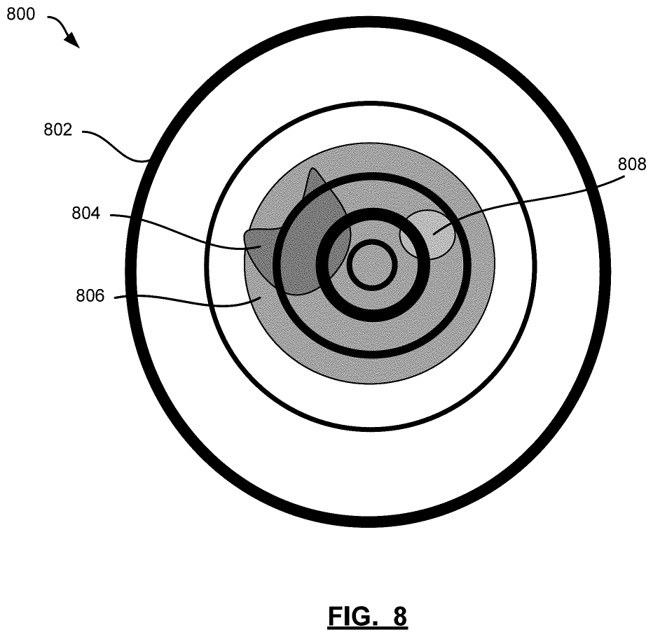

FIG. 8 is a diagram of a sensing device output, according to an example embodiment. FIG. 8 shows an image with a spectrophotometric signal including a set of concentric circles of varying thickness around it representing the spectral comb information passing the dispersion and bandpass filter combination.

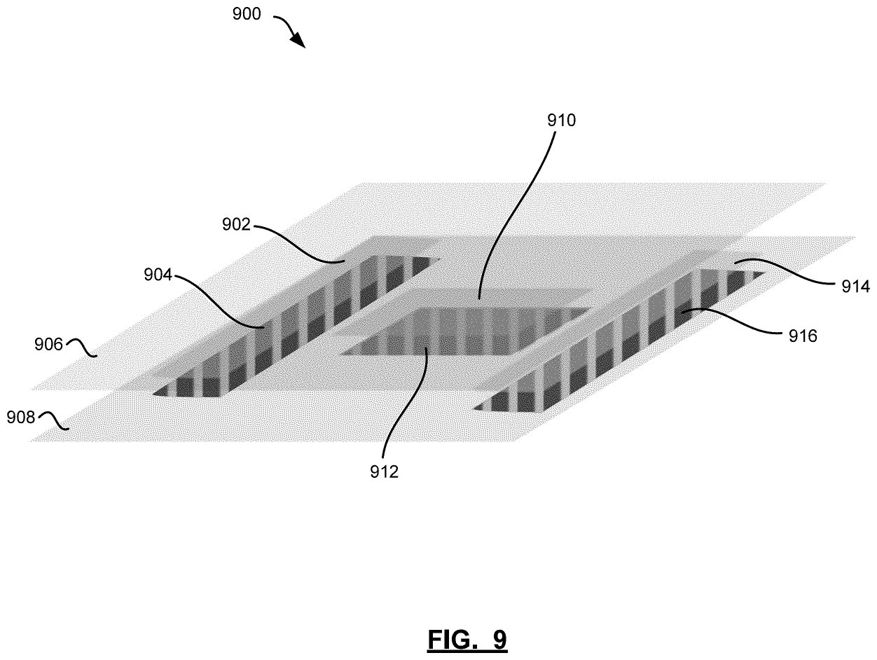

FIG. 9 is a diagram showing a transverse contacting embodiment of an imaging system, according to at least one embodiment. The conventional electrical contact methodology for photodetectors uses optical and electrical field directions which are parallel to one another. In at least one embodiment taught herein, a transverse electric field optical direction contacting is used. Transverse contacting can improve device performance as the resulting signal is less dependent on absorbance length matching (i.e. sensor material thickness) and this provides for repeatable manufacturing. Transverse contacting can improve device performance as the quantum efficiency of the device can reach the full potential for device theoretical sensitivity, which is 13% better than the best longitudinal devices. Furthermore, transverse contacting can also improve the noise performance of the device, improving overall contrast performance of the device. Conventionally, existing sensors are created using a vertical stack using materials like Indium-Tin (In2O3/Sn2O2) Oxide or Aluminium doped Zinc Oxide. This includes conventional methods of treating the materials to make the sensors, configuring the specific band of quantum dots and the configuration of the optoelectronic couplers.

Transparent conductors such as ITO (Indium-Tin-Oxide) can be limiting in use with transparent materials. However, conventional vertical topology stack further limits the usefulness of transparent conductors. It may be desired to boost quantum efficiency of the material and amplify the signal that is received from the sensor. In one embodiment, the imaging system 900 can include a transverse stack configuration. The transverse stack configuration can consist of a composition including contact-gap-contact strategy, with the semiconductor on top. The transverse stack configuration can provide improved IR performance. The integration of the components together results in a compact, infrared spectral imager that produces curved fringes that are super imposed on an image where the relative intensity distribution along a radial line of consistent background imagery provides the envelope of image portion's spectroscopic content.

### Methods of Fabricating the Sensor

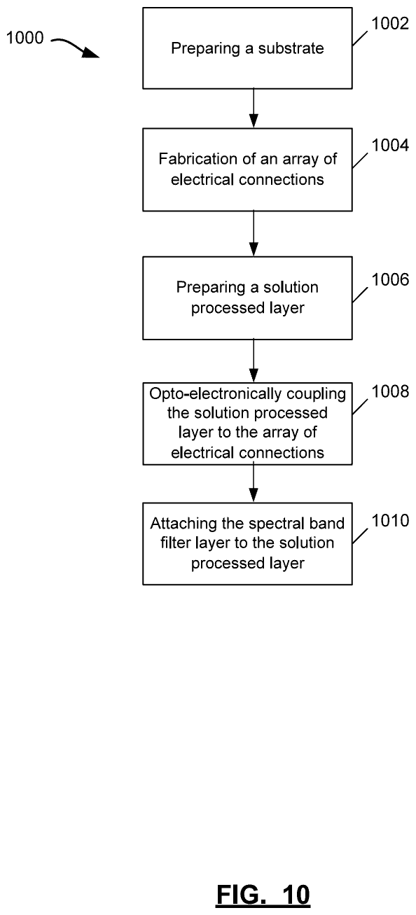

FIG. 10 flowchart showing a method of fabricating a sensing device, according to at least one embodiment. The steps required to fabricate the sensor are as follows: prepare substrate; opto-electronically couple the solution processed material (like quantum dots) to the FPA; and attach the spectral band filter layer. A method for manufacturing the sensor devices can include a special procedure for the quantum dots, or other solution processed material, to opto-electronically couple the sensor material itself.

At 1002, preparing a substrate involves: cleaning of the substrate; exposure of trenching regions with photo-resist; developing of photo-resist for re-entrant profile sidewalls toward a self-aligned processing; etching into substrate material to either contact exiting metal layers or define new metal regions with the expectation of planarizing the finished surface within less than 1000 nanometers of topography for non-bump bonding electrical interfaces to sensor material or contacts; deposition of metal(s) that are optimized for conductivity in 3D and/or semiconductors with total thickness in the 10 to 1000 Angstrom range, with often a second pre-etch step before deposition; and lift-off in solvent and a final protection with PR or some other material.

At 1004, fabricating a an array of electrical connections on the substrate involves: solution processed spin-coating, blade casting, dip-coating or other form of directed solution casting of sensor materials or, direct metal-metal interfacing where the sensor material metal contacts and that of the substrate metal contacts are coplanar across the die and electrically connect the regions contacts to the substrate without bump-bonds like, for example, in InGaAs Cu—Cu bonding.

In the specific case of solution processed materials typically the material may undergo a form of ligand treatment to enhance optoelectronic performance by reducing the inter dot spacing of the colloids while passivating recombination centers. This typically results in a non-dispersed and albeit closer packed phase where carrier transport is enhanced. Also, where one of the contacting elements, to the substrate, can start as a solution processed material.

In the case of non-bump bonded co-planar metal-metal material hybridization, or for solution processed materials, the focal plane array is typically one or many materials that can be added and organized to improve transport of contact through carrier blocking layers, and other materials to form the elements of photodetector arrays: photodiodes, photoconductors, or phototransistors.

At 1006, preparing a solution processed layer may involve: deposition of the electrical contacts; material work function deposition; material deposition of carrier blocking regions; and depositing semiconductor material layers for the formation of photodetectors. In at least one embodiment, depositing semiconductor material layers involves depositing a layer of quantum dots, where ligand exchange, either in-situ or ex-situ, enhances carrier transport properties. The deposited structures are engineered to create photodetector elements, including capping layers for additional transport engineering elements.

At 1008, optoelectronically coupling the solution processed layer to the array of electrical connections involves: spin coating the quantum dot solution onto an engineered contacting layer planarized substrate with topography that does not impede the resulting imaging in an unrecoverable way; cross linking of quantum dots with inorganic or organic ligands including, but not limited to: ethanedithiol or others, mercaptan, carboxylates, amines, and halogens. In at least one embodiment, optoelectronically coupling solution processed layer to the array of electrical connections further includes optional cleaning steps and the addition of extra quantum dot layer(s), crosslinker(s) and solvent(s) steps.

At 1010, attaching the spectral band filter layer to the solution processed layer may involve: Deposition of high and low refractive index materials including, but not limited to: amorphous silicon, silicon dioxide, silicon nitride, tantalum pentoxide, or BK7 on a substrate. In at least one embodiment, another material designed to accept a specific wavelength range in a designed optical acceptance angle and reject, in full or in part, other wavelengths or angles of incidence from reaching the sensor material, which is often fixed in place with an epoxy. In addition, the filter can be thermally coupled to a cold temperature region to limit self-emission from degrading the performance of the sensor material.

Conventional methods for manufacturing infrared spectral imager sensors using infrared epitaxy can be cost-prohibitive due to the limited selection of infrared substrate materials (such as InP, GaAs, and CdTe). These materials typically allow for manufacturing only about 50 sensors per wafer due to constraints related to hybridization to readout circuits, wafer diameter, and defects.

In at least one embodiment, the method includes a substrate-free device nucleated growth phase. In at least one embodiment, the devices can be directly deposited on silicon substrate readout circuits allowing for more sensors per wafer (˜11,000) as shown in FIG. 1A, leading to a more cost-effective fabrication method. The solution-processed semiconductor deposition method also provides a sensor film deposition technology that operates over a wider range of wavelengths than traditional infrared epitaxials. First, there is no substrate block of the bluer wavelengths from the band gap energies for the sensor materials (for example, enabling sensitivity to the blue and UV wavelengths that other infrared materials cannot access due to substrate absorption). Also, it accesses further into the red wavelength than a lattice matched bandgap substrate owing to two factors: exciton confinement and lower dark-current performance relative to lattice mismatched epitaxial performances, as compared to the conventional InGaAs and Si based sensors.

### Software and Electronics of the Camera

Connecting to the sensor device is a processor that processes the sensor data and generates spectral data from the IR video frame data. The device is responsible for receiving electrical signals from the FPA and converting this data to the digital domain. The dispersion layer of the sensor device provides a spectral signal superimposed upon the video signal. This hybrid signal is the combination of a spectrometer signal and a normal image.

The processor(s) are responsible for transmitting and outputting the video signal but may also perform interpretation and analysis tasks. The hybrid signal, including the video signal and the spectral signal may be analysed. This may include analysis by software running on the processor(s) or by cloud-based analysis tools that receive the hybrid signal over a network connection. This modelling may include identifying the concentration/flux of methane release in a 2D plane in the area of interest and modelling the 3D volume. This can include analysis of multiple video frames or multiple spectral sub-images.

The quantification of gases is based on an algorithmic quantification of emission. These address existing requirements for measuring GHG emissions. The quantification is based on the input data including the video frames and the spectral signal generated by the dispersion signal. The spectral signal is analogous to a spectrophotometer signal. It includes absorption peaks as a function of wavelength. This image is produced based on a Fourier transform including frequency information in rings that are superimposed that are proportional to absorption features. The video signal provides edges of a plume, and by consideration of the flow rate of the suspected device, the edges of the plume and the spectral signal may be used to estimate the volumetric off-gassing.

In one embodiment, a software program can be used to deconvolve the imagery from the spectrophotometric data set. The software program can be running on the processor of the device. The software program can include a centroid finding function for finding fringes. The software program can include an identification function of constant background regions, either autonomously or manually defined. The software program can further include a sorting function for selecting region's regions by radial distance from the centroid. The software program can further include a nonlinearity correction function, which can include a gain and offset uniformity correction of the camera typically using a standard light and dark frame capture. Selected regions can be averaged, and the spectrum of intensity vs wavelength can be computed.

While the applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without departing from the embodiments, the general scope of which is defined in the appended claims.

1. A sensor device comprising:
a readout integrated circuit;
an array of electrical contacts mounted to the readout integrated circuit;
a solution processed layer deposited on top of the array of electrical contacts; and
a spectral band filter layer deposited on top of the solution processed layer,
wherein:
the spectral band filter layer is optically aligned with the solution processed layer; and
the readout integrated circuit, the array of electrical contacts and the solution processed layer form together a focal plane array for receiving light from a lens device.

2. The sensor device of claim 1,
wherein the spectral band filter layer is configured to permit a propagation of incident light within a first wavelength band therethrough while preventing a propagation of incident light of the second light therethrough, the first wavelength band corresponding to features within the received light of molecules of interest.

3. The sensor device of claim 2, wherein the spectral band filter layer comprises at least a first layer and a second layer, a refractive index of the first layer greater than a refractive index of the second layer.

4. The sensor device of claim 3, wherein a gap between the first layer and the second layer is adjustable, and the adjustment of the gap adjusts the first wavelength band and the second wavelength band.

5. The sensor device of claim 4, further comprising an adjustment means for providing the adjustment of the gap.

6. The sensor device of claim 3, wherein the first wavelength band comprises a first range from 2000 nm to 2500 nm and the second wavelength band comprises a second range from 500 nm and 1900 nm and a third range above 2500 nm.

7. The sensor device of claim 6 wherein the spectral band filter layer comprises a bandpass filter.

8. The sensor device of claim 7 wherein the spectral band filter layer comprises a Fabry-Perot etalon.

9. The sensor device of claim 7 wherein the spectral band filter layer and the solution processed layer comprise a Fabry-Perot etalon.

10. The sensor device of claim 8 further comprising an adhesive layer positioned between the spectral band filter layer and the solution processed layer, the adhesive layer securing the spectral band filter layer and the solution processed layer.

11. The sensor device of claim 10, wherein the sensor device comprises a horizontal/transverse stack configuration.

12. The sensor device of claim 11, wherein the solution processed layer comprises quantum dots.

13. The sensor device of claim 12, further comprising at least one microlens structure adjacent to the spectral band filter layer.

14. A method for fabricating a sensor device, the method comprising:
depositing (or mounting) an array of electrical contacts on a readout integrated circuit;
depositing a solution processed layer on top of the array of electrical contacts; and
depositing a spectral band filter layer on top of the solution processed layer; e spectral band filter layer being optically aligned with the solution processed layer,
wherein the readout integrated circuit, the array of electrical contacts and the solution processed layer form together a focal plane array for receiving light from a lens device.

15. A camera device for sensing spectrophotometric and image data, the camera device comprising:
a lens for transmitting incident light;
a dispersion device for dispersing the incoming light into a spectrophotometric signal comprising spectrometer data;
the sensor device of claim 1 for receiving an image from the lens and the spectrophotometric signal from the dispersion device.

16. The camera device of claim 15 wherein the dispersion device exhibits a Fabry-Perot behavior.

17. The camera device of claim 16 wherein the spectrophotometric signal comprises an interference pattern.

18. The camera device of claim 17 wherein the spectrophotometric signal comprises a set of concentric circles superimposed upon the image.

19. The camera device of claim 18 wherein the dispersion device is tuned to a resonant frequency of Methane (CH₄).

20. The camera device of claim 19 further comprising a processor in communication with the sensor device, the processor receiving the image and the spectrophotometric signal.

21. The camera device of claim 20 further comprising:
a memory in communication with the processor, the memory comprising program instructions which when executed by the processor provide a machine vision algorithm for processing the received image and the spectrophotometric signal.
